(19) United States
(12) Patent Application Publication
(10) Pub. No.: US 2021/0063148 A1
(43) Pub. Date: Mar. 4, 2021

(54) METHOD AND DEVICE FOR OPERATING AN ACOUSTIC SENSOR

(71) Applicant: Robert Bosch GmbH, Stuttgart (JP)

(72) Inventor: Michael Schumann, Stuttgart (DE)

(21) Appl. No.: 16/960,015

(22) PCT Filed: Jan. 15, 2019
(86) PCT No.: PCT/EP2019/050863

§ 371 Date: Jul. 2, 2020

(30) Foreign Application Priority Data
Jan. 17, 2018 (DE) 10 2018 200 688.1

(51) Int. Cl. G01B 17/02; G01S 15/88; G01S 15/10

(52) U.S. Cl. CPC G01B 17/02; B60R 19/483; G01S 15/10; G01S 15/88

(57) ABSTRACT

A device and a method for operating an acoustic sensor. An acoustic signal is emitted with the aid of the acoustic sensor, a first signal component of the acoustic signal having a first frequency and a second signal component of the acoustic signal having a second frequency, an aperture angle of the acoustic sensor differing for the first frequency and the second frequency, receiving the acoustic signal with the aid of the acoustic sensor, after it has been reflected at an object; and evaluating the received acoustic signal to ascertain an elevation angle based on a signal amplitude of the first signal component and a signal amplitude of the second signal component of the received acoustic signal, the elevation angle describing a position deviation of the object from a sensor axis of the acoustic sensor.

### FIELD

The present invention relates to a method and a device for operating an acoustic sensor.

### BACKGROUND INFORMATION

In surroundings detection systems in the automotive field, it is desirable to be able to determine the height of an object, to thus classify an ability to drive over the object.

Ultrasonic systems including up to six sensors per bumper are typically used for surroundings detection in the close-up range of a vehicle. The systems from the related art, since they are installed in a plane, may detect the lateral position of an object via trilateration, but the object position cannot be determined in an elevation.

One approach for nonetheless determining the ability to drive over is to track the echo amplitude curve. Reflections at sensor level display a higher signal amplitude during approach than objects close to the ground, whose echo amplitude decreases strongly due to the narrow vertical aperture angle. However, this approach fails if relative movement does not take place between object and vehicle. This is the case, for example, if the vehicle is stationary or moves perpendicularly to the object.

In highly-automated systems, the application of driving authorization after startup (vehicle is stationary) has particular significance. Knowledge of an object height is already required for this purpose, the vehicle typically being stationary.

### SUMMARY

An example method according to the present invention for operating an acoustic sensor includes emitting an acoustic signal with the aid of the acoustic sensor, a first signal component of the acoustic signal having a first frequency and a second signal component of the acoustic signal having a second frequency, an aperture angle of the acoustic sensor differing for the first frequency and the second frequency, receiving the acoustic signal with the aid of the acoustic sensor after it has been reflected at an object, and evaluating the received acoustic signal to ascertain an elevation angle based on a signal amplitude of the first signal component and a signal amplitude of the second signal component of the received acoustic signal, the elevation angle describing a position deviation of the object from a sensor axis of the acoustic sensor.

An example device according to the present invention for operating an acoustic sensor includes a control device, which is configured to emit an acoustic signal with the aid of the acoustic sensor, a first signal component of the acoustic signal having a first frequency and a second signal component of the acoustic signal having a second frequency, an aperture angle of the acoustic sensor differing for the first frequency and the second frequency, receiving the acoustic signal with the aid of the acoustic sensor after it has been reflected at an object, and evaluating the received acoustic signal to ascertain an elevation angle based on a signal amplitude of the first signal component and a signal amplitude of the second signal component of the received acoustic signal, the elevation angle describing a position deviation of the object from a sensor axis.

The acoustic sensor is a sensor which operates on the echo principle. The aperture angle of the acoustic sensor is an angle which defines an area into which the acoustic signal is emitted by the acoustic sensor into its surroundings. The aperture angle describes in particular an angle between the sensor axis and a transmission direction originating from the acoustic sensor, a signal amplitude of the acoustic signal for an associated frequency significantly decreasing if the angle is greater than the aperture angle. The aperture angle associated with the frequency is usually not sharply delimited. The aperture angle typically specifies the angle at which the emission amplitude drops by 3 dB. However, it is not necessary according to the present invention to know the aperture angle associated with a frequency accurately, as long as the aperture angle of the acoustic sensor differs for the first frequency and the second frequency with equivalent observation. It is thus sufficient if the aperture angle is known, a rough and thus not accurate specification of the aperture angle being sufficient.

The received acoustic signal is the emitted acoustic signal reflected at an object. Therefore, the received acoustic signal also includes the first signal component and the second signal component of the acoustic signal. This means that the received acoustic signal and the emitted acoustic signal include signal components corresponding to one another.

The elevation angle is an angle between the sensor axis and a transmission direction, in which the object is located, at which the acoustic signal was reflected. An elevation of the object is described by the elevation angle with corresponding attachment of the acoustic sensor. However, it is to be noted that with a corresponding arrangement of the acoustic sensor, a location of the object in relation to the acoustic sensor in a horizontal plane may also be ascertained.

According to the present invention, a variation of the aperture angle of the acoustic sensor is carried out by changing a frequency of the acoustic signal. A change of the aperture angle of the acoustic sensor is thus achieved by modulating the emission frequency. It is to be noted that this is already the case in a variety of present ultrasonic sensors, without these having been especially developed for this purpose. The example method according to the present invention for operating an acoustic sensor or the associated example device may thus be used with a variety of acoustic sensors, which are often also available particularly cost-effectively. However, this does not preclude that the method according to the present invention and the device according to the present invention may also be operated using acoustic sensors which are especially designed in such a way that an aperture angle of the acoustic sensor changes with the frequency of the acoustic signal.

Preferred refinements of the present invention are described herein.

The acoustic signal is preferably a chirp. A chirp is a signal having a frequency that changes, in particular changes continuously, over a time curve. In particular, many frequencies, i.e., in particular many signal components of different frequencies, are provided in an acoustic signal by such a chirp. At the same time, a further optimization of the acoustic sensor for its surroundings may take place by a chirp, thus, for example, the acoustic signal of the acoustic sensor may be differentiated after a reflection at the object from those signals which are emitted by other sensors.

It is also advantageous if the acoustic signal is a pulsed signal having pulses each of constant frequency. It is thus particularly simple to identify a signal component of the emitted acoustic signal in the received acoustic signal. The method using pulsed fixed frequencies, i.e., a use of a pulsed signal having pulses each of constant frequency, functions particularly well if a large number of pulses having different frequencies is used.

It is also advantageous if a standardization of the signal amplitudes of the first signal component and the second signal component takes place during the evaluation of the received acoustic signal, and the elevation angle is ascertained based on a standardized signal amplitude of the first signal component and a standardized signal amplitude of the second signal component of the received acoustic signal. During the standardization, the signal amplitudes are preferably multiplied by a frequency-dependent correction factor. It is thus possible to compensate during an evaluation for the fact that a signal amplitude of those signal components with which a wider aperture angle is associated is usually less than a signal amplitude of those signal components with which a smaller aperture angle is associated, since an energy of the particular signal component is emitted in a more focused manner at a smaller aperture angle.

It is also advantageous if, during the evaluation of the received acoustic signal, a directional pattern of the acoustic sensor is accessed, which defines a relationship between signal amplitudes of the received acoustic signal and elevation angle for the first frequency and for the second frequency. All pieces of information relevant for the evaluation are compiled into a single data set by the directional pattern of the acoustic sensor. The directional pattern is preferably described by tables or curves.

It is also advantageous if the evaluation of the received acoustic signal to ascertain the elevation angle includes a trilateration, a location of the object in relation to the acoustic sensor being described in an azimuth angle, in particular in a horizontal direction in relation to the acoustic sensor, and a correction of the directional pattern taking place based on the azimuth angle. An influence of a position deviation of the object in a direction which is not described by the elevation angle may thus be compensated for.

It is also advantageous if a horizontal aperture angle of the acoustic sensor is greater than a vertical aperture angle of the acoustic sensor. The vertical aperture angle is an angle which lies in a shared plane with the elevation angle. The horizontal aperture angle is an angle which lies in a plane perpendicular to the shared plane in which the elevation angle lies. A corresponding arrangement of the acoustic sensor preferably takes place, so that the horizontal aperture angle lies in a horizontal plane and the vertical aperture angle lies in a vertical plane. The horizontal aperture angle is preferably in a range of ±60°, the vertical aperture angle is preferably in a range of ±30°. A deviation of 5° is preferably to be considered with the range. At such aperture angles, the advantage results that influence of undesirable reflections, in particular ground reflections, is kept small and at the same time the difference for the aperture angle for different frequencies is greater in the vertical direction than in the horizontal direction. A height of objects may thus be recognized particularly well.

The acoustic sensor is preferably an ultrasonic sensor which has a diaphragm cup design. Such acoustic sensors are widespread and already include the properties necessary for the acoustic sensor. It is thus possible to apply the method to already existing sensor systems.

Furthermore, it is advantageous if the evaluation of the received acoustic signal, to ascertain an elevation angle, is carried out in response to a system including the acoustic sensor having been started or a presence of an object having been detected. In particular, the method is repeated until a predetermined period of time has elapsed, an object is no longer detected, or an alternative system is ready for operation. Just when the system including the acoustic sensor has been started, there is often a situation in which, for example, a vehicle including the system is located at a standstill and other methods for ascertaining an elevation angle are not functional. Particularly simple signal processing may be achieved if the evaluation according to the present invention of the received acoustic signal is only started if an object has been detected at all. System resources and energy may be saved in this way.

### BRIEF DESCRIPTION OF THE DRAWINGS

Exemplary embodiments of the present invention are described in detail hereinafter with reference to the figures.

FIG. 1 shows a representation of a flow chart of a method for operating an acoustic sensor according to one specific example embodiment of the present invention.

FIG. 2 shows a schematic representation of a device for operating an acoustic sensor according to one specific example embodiment of the present invention.

FIG. 3 shows a graphic representation of a directional pattern of an acoustic sensor, which represents a relationship between an elevation angle, a signal amplitude of the received acoustic signal, and an associated frequency.

### DETAILED DESCRIPTION OF EXAMPLE EMBODIMENTS

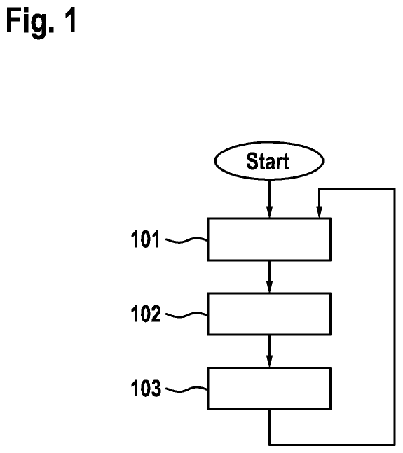

FIG. 1 shows a flow chart of a method for operating an acoustic sensor 1 according to one specific example embodiment of the present invention. The method is carried out by a device for operating acoustic sensor 1, the device including a control device 4 and acoustic sensor 1.

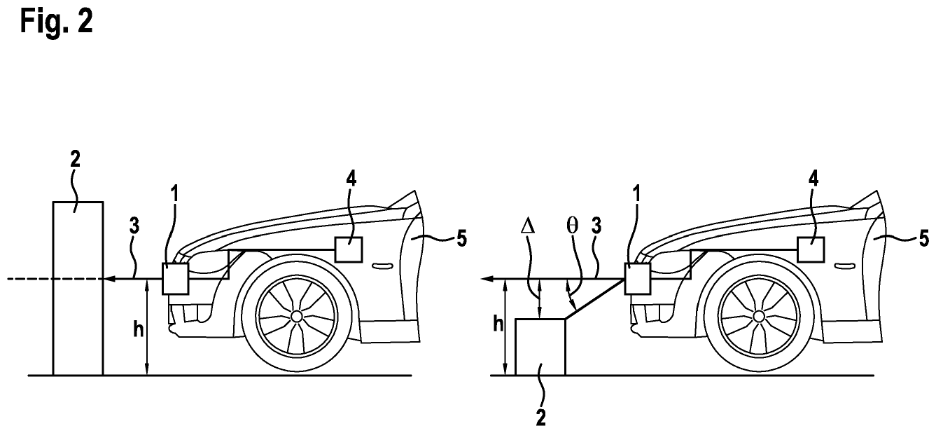

The example device for operating acoustic sensor 1 is shown in FIG. 2, the device being situated at a vehicle 5. Acoustic sensor 1 is situated on a front of vehicle 5. Acoustic sensor 1 is coupled to control device 4, which is, for example, an analog signal processing unit, which includes a filter bank, for example, or a digital signal processing unit. A sensor axis 3 of acoustic sensor 1 is aligned in such a way that surroundings of vehicle 5 located ahead of vehicle 5 are detected. Those objects 2 which are located ahead of vehicle 5 are thus detected with the aid of acoustic sensor 1.

Acoustic sensor 1 has a primary detection direction. This primary detection direction is described by a sensor axis 3 of acoustic sensor 1. This means, for example, that acoustic sensor 1 has a maximum range in the direction of sensor axis 3. It is apparent that sensor axis 3 is not a physical component, but rather merely describes a property of acoustic sensor 1.

The example method according to the present invention is started when the device for operating acoustic sensor 1 is put into operation. This is typically the case when vehicle 5 is put into operation. A first method step 101 of the method according to the present invention is thus carried out in response in that a system including acoustic sensor 1 is started.

In first method step 101, an emission of an acoustic signal takes place with the aid of acoustic sensor 1, a first signal component of the acoustic signal having a first frequency and a second signal component of the acoustic signal having a second frequency. Thus, either a chirp is emitted by the acoustic sensor or a pulsed signal having pulses each of constant but different frequency is emitted. If the acoustic signal is a chirp, it thus has a frequency continuously changing over time. The first signal component and the second signal component are specific time ranges in the chirp. If the acoustic signal is a pulsed signal including pulses each of constant frequency, an acoustic signal is thus emitted having the first frequency for a first period of time and the acoustic signal is emitted having the second frequency for a period of time subsequent thereto. The time range of the acoustic signal in which it has the first frequency is referred to as the first signal component, the component of the acoustic signal in which it has the second frequency is referred to as the second signal component. The acoustic signal may include further signal components of arbitrary frequency between the first signal component and the second signal component. Alternatively, the second signal component takes place chronologically immediately after the first signal component.

The acoustic signal may include any number of signal components, which are evaluated using the same method. The more “frequency support points” exist, the better the method functions and the more accurate the angle ascertainment becomes. If the acoustic signal is a linear chirp, the advantage results that many frequencies are passed through within a short time and thus many support points exist.

An aperture angle of acoustic sensor 1 is different for the first frequency and the second frequency. The aperture angle is an angle between a direction originating from acoustic sensor 1 and sensor axis 3, a signal amplitude of the acoustic sensor being greater within the transmission direction of acoustic sensor 1 defined by the aperture angle than outside this transmission direction defined by the aperture angle. Accordingly, a signal amplitude of an acoustic signal reflected from object 2 is greater if reflecting object 2 is located in the transmission direction of acoustic sensor 1 defined by the aperture angle than if it is located outside this. Accordingly, in the case of the location of object 2 illustrated by way of example on the left in FIG. 2, the reflected acoustic signal would have a higher signal amplitude than in the case of the location of object 2 illustrated by way of example on the right in FIG. 2. This applies both to the first signal component having the first signal frequency and also to the second signal component having the second signal frequency.

The aperture angle does not define a sharply delimited area. Reflections of the acoustic signal may thus also be reflected to acoustic sensor 1 and received if they are located outside an area defined by the aperture angle. However, a signal amplitude of the reflected acoustic signal and thus of the received acoustic signal drops at different rates for the first frequency and the second frequency if object 2 is moved out of sensor axis 3.

Acoustic sensor 1 is an ultrasonic sensor in the specific embodiment described here. It has a diaphragm cup design. This means that a base of a diaphragm cup is used as a diaphragm and is excited into oscillations with the aid of an exciting element, for example, a piezoelectric element. Such ultrasonic sensors having a diaphragm cup design are widespread and have a favorable directional pattern. Ultrasonic sensors have an oriented sound emission and sensitivity both in the vertical and in the horizontal. The horizontal aperture angle is typically in the range of ±60° and the vertical aperture angle is ±30°. The narrow sound emission in the vertical is in order to avoid undesirable ground reflections, since these cause a higher fade-out threshold and thus a lower sensitivity of the sensor.

The aperture angle of the sound emission is dependent on the ratio of wavelength to diaphragm cup diameter in ultrasonic sensors having a diaphragm cup design. The diameter is a fixed geometric design feature of the transducer and naturally cannot be changed during operation. The wavelength, in contrast, may be influenced by the transmission frequency. To achieve the typical above-mentioned aperture angles, the sensors are typically operated around 48 kHz at approximately 15 mm diaphragm external diameter. At higher transmission frequencies, smaller aperture angles result, and larger aperture angles result at lower frequencies. The frequency-dependent directional pattern resulting therefrom is thus also a design feature of a transducer.

Alternatively, other acoustic sensors may also be used, since many acoustic sensors have a different aperture angle for different frequencies. Acoustic sensor 1 is preferably such a sensor, in the case of which this behavior is particularly pronounced.

After first method step 101, a second method step 102 is carried out. In second method step 102, a reception of the acoustic signal takes place with the aid of acoustic sensor 1, after it has been reflected at object 2. The received acoustic signal and thus the reflected acoustic signal is converted by acoustic sensor 1 into an electrical signal and provided to control device 4. In a following third method step 103, the electrical signal and thus the received acoustic signal is evaluated.

During the evaluation of the received acoustic signal, an elevation angle θ is ascertained based on a signal amplitude of the first signal component and a signal amplitude of the second signal component of the received acoustic signal, the elevation angle describing a position deviation of object 2 from sensor axis 3 of acoustic sensor 1. In FIG. 2, elevation angle θ is an angle which is located in the plane of the drawing shown. In relation to vehicle 5, elevation angle θ is thus a vertical angle. In the scenario shown by way of example on the left in FIG. 2, at least parts of object 2 are located directly on sensor axis 3. The deviation of object 2 from the sensor axis is thus equal to zero or may be described by elevation angle θ of 0°. In the scenario shown by way of example on the right in FIG. 2, object 2 does not extend up into sensor axis 3, but rather it is so low that it is located below sensor axis 3. The position of object 2 thus deviates from sensor axis 3. This may either be described by a distance Δ, which is a shortest distance between object 2 and sensor axis 3, or may be described by elevation angle θ, which exists between sensor axis 3 and a straight line which connects acoustic sensor 1 to object 2. It is apparent that a direct geometric dependence exists here between elevation angle θ and distance Δ. Elevation angle θ is ascertained hereinafter. However, it is to be noted that distance A may also be ascertained, since a distance to object 2 is also known by acoustic sensor 1 with the aid of the echo principle and thus a conversion is possible. Elevation angle θ does not necessarily have to be ascertained as an exact value.

It is thus sufficient to ascertain, for example, whether elevation angleθ is greater or less than a predefined value to recognize an ability to drive over an object 2.

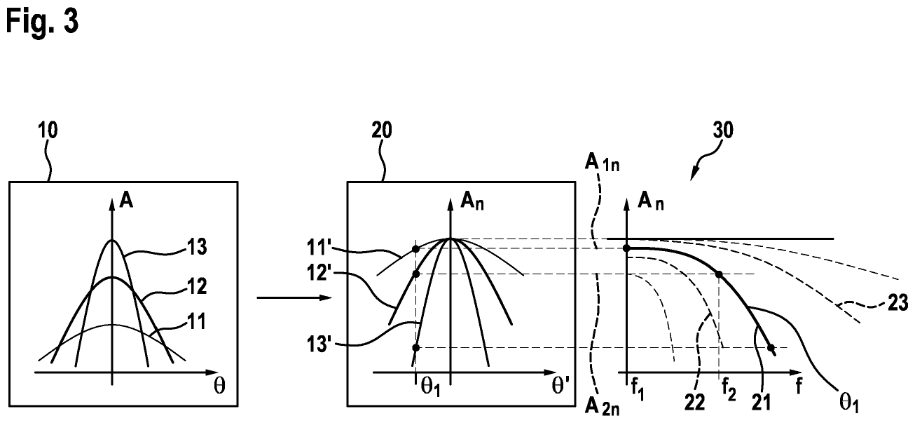

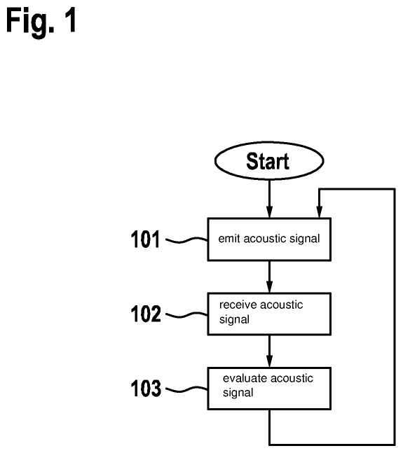

During the evaluation of the received acoustic signal, a directional pattern 10 of acoustic sensor 1 is accessed by control device 4. This directional pattern 10 defines a relationship between signal amplitude and elevation angle of the received acoustic signal for the first frequency and the second frequency. Such a directional pattern 10 is shown by way of example in FIG. 3. A directional pattern 10 before a standardization is shown on the left in FIG. 3. A vertical directional pattern of the echo amplitude is shown having a dependence on the transmission frequency of acoustic sensor 1. The directional pattern is shown after a standardization in the middle in FIG. 3. A standardized vertical directional pattern 20 having dependence on the transmission frequency is thus shown in the middle. A representation 30 of standardized directional pattern 20 is depicted on the right in FIG. 3, in which a curve of the echo amplitudes is shown upon variation of the transmission frequency for reflections from different elevation angles θ.

Reference is initially made to directional pattern 10 shown on the left in FIG. 3. It is stored as a data set in control device 4 and was ascertained beforehand, for example, by computer or experimentally. In directional pattern 10, elevation angle θ is shown on an X-axis and signal amplitude A of the received acoustic signal is shown on a Y-axis. The signal amplitude of the received acoustic signal is provided for each elevation angle θ, which is to be expected if the acoustic signal was reflected at an object 2, whose location in relation to acoustic sensor 1 is described by particular elevation angle θ. For this purpose, a first curve 11, a second curve 12, and a third curve 13 are shown in directional pattern 10. First curve 11 is associated with the first frequency, which is 40 kHz, for example. Second curve 12 is associated with the second frequency, which is 48 kHz, for example. Third curve 13 is associated with a third frequency, which is 60 kHz, for example. There is an elevation angle θ of 0° in the origin of the diagram shown. It is apparent that a signal amplitude of the received acoustic signal has a maximum for elevation angle θ of 020 for each of the first through third frequencies. The farther object 2 deviates from sensor axis 3, i.e., the greater elevation angle θ becomes, the lower the signal amplitude of the received acoustic signal is for the associated transmission direction. It is apparent that the signal amplitude drops with elevation angle θ at different speeds for the different frequencies. The position of object 2, i.e., elevation angle θ, may be deduced from this difference. For this purpose, in this specific embodiment, initially a standardization of the signal amplitudes of the first signal component and the second signal component follows during the evaluation of the received acoustic signal. Elevation angle θ is ascertained in the further course of the method based on the standardized signal amplitude of the first signal component and a standardized signal amplitude of the second signal component of the received acoustic signal.

During the standardization, the values of first through third curve 11 through 13 are multiplied by an amplification factor. This is selected for each of curves 11 through 13 so that the particular one of first through third curve 11 through 13 is displaced along the vertical axis in such a way that all curves 11 through 13 have an equal value for an elevation angle θ of 0°. This is shown in standardized directional pattern 20 shown in the middle in FIG. 3. In standardized directional pattern 20, elevation angle θ is shown on an X-axis and standardized signal amplitude Aₙ of the received acoustic signal is shown on a Y-axis. A standardized first curve 11′ is thus shown, which is associated with the first frequency, a standardized second curve 12′ is shown, which is associated with the second frequency, and a standardized curve 13′ is shown, which is associated with the third frequency. Standardized first, second, and third curve 11′, 12′, and 13′ thus have the same value for elevation angle θ of 0°.

Measured signal amplitudes of the first signal component and the second signal component of the received acoustic signal of associated elevation angle θ are ascertained based on standardized directional pattern 20.

This ascertainment of associated elevation angleθ will be described by way of example based on illustration 30 shown on the right in FIG. 3 of standardized directional pattern 20. In illustration 30 shown, a separate curve is shown for each elevation angle θ. It is thus apparent that, for example, the signal amplitudes present for a first elevation angle θ₁ for the first through third frequency lie on a shared curve. This curve is shown on the right in FIG. 3 as a first elevation curve 21. This also applies accordingly for elevation angles other than first elevation angle θ₁. Thus, for example, the signal amplitudes present for a second elevation angle θ₂ for the first through third frequency also lie on a shared curve. This curve, shown on the right in FIG. 3, is a second elevation curve 22. A separate curve results for each possible elevation angle θ in illustration 30 shown on the right in FIG. 3 of standardized directional pattern 20.

The curves shown in FIG. 3 correspond to one another in the information content. Control device 4 may thus arbitrarily access one of these curves and evaluate it accordingly. In the specific embodiment of the present invention described here by way of example, the acoustic signal includes the first signal component, which has the first frequency, and the second signal component, which has the second frequency.

It is assumed as an example that the first frequency has value f1 and the second frequency has value f2. It is assumed simultaneously that a value of the signal amplitude of the received acoustic signal has value A1 for the first signal component and thus for the first frequency. Furthermore, it is assumed that a value of the signal amplitude of the received acoustic signal has value A2 for the second signal component and thus for the second frequency. The points thus defined are shown on the right in FIG. 3. It is apparent that they lie on a shared curve, on first elevation curve 21 here, this curve being associated with a specific elevation angle θ, first elevation angle θ₁ here. Associated elevation angle θ thus ascertained describes the position deviation of object 2 from sensor axis 3.

Control device 4 thus ascertains, in the specific embodiment described here, a signal amplitude of the received acoustic signal for the first signal component and the second signal component and standardizes it, in that it multiplies it by the amplification factor associated with the particular frequency.

Based on these standardized signal amplitudes and the known frequencies, an associated elevation curve may thus be identified, which is associated with an elevation angle θ. Associated elevation angle θ thus ascertained describes the position deviation of object 2 from sensor axis 3.

Two frequencies are sufficient to determine the position deviation of object 2 from sensor axis 3. However, it results that a further improvement of an accuracy and reliability is achieved if the acoustic signal furthermore includes a signal component having the third frequency or further frequencies. In particular, if the acoustic signal is a chirp, it is furthermore advantageous if an evaluation with respect to a multitude of frequencies follows, since the received acoustic signal also includes a multitude of frequencies.

In some acoustic sensors 1, the problem results that during the above-described evaluation of the acoustic signal, it is not possible to differentiate whether object 2 is outside sensor axis 3 in the horizontal direction or in the vertical direction. It is therefore advantageous if acoustic sensor 1 includes a horizontal aperture angle which is greater than a vertical aperture angle of acoustic sensor 1. This proves to be advantageous, on the one hand, since with such an arrangement an influence of ground reflections on the received acoustic signal is minimized. Furthermore, it thus results that there is a smaller deviation of the aperture angle between the first frequency and the second frequency in the horizontal direction. A movement of object 2 in the vertical direction in relation to acoustic sensor 1 will thus have hardly any influence on ascertained elevation angle θ.

Optionally, a trilateration takes place based on the measured values of multiple acoustic sensors to determine a location of the object in relation to the acoustic sensor in an azimuth angle, which describes a location of object 2 in relation to acoustic sensor 1 in a horizontal direction. A correction of directional pattern 10 takes place based on the azimuth angle. For this purpose, a selection of directional pattern 10 takes place based on the azimuth angle, a separate directional pattern 10 being stored for each azimuth angle. An influence of a position deviation of object 2 in a direction which is not described by elevation angle e may thus be compensated for and does not result in a corruption of ascertained elevation angle θ.

Ascertained elevation angle e describes the position deviation of object 2 from sensor axis 3 and is provided for a further use. Elevation angle θ is thus provided together with a distance to object 2 detected by acoustic sensor 1 for a system by which an ability to drive over objects is estimated. For this purpose, for example, a threshold value is provided based on the detected distance, which describes an associated elevation angle θ, which is not permitted to be fallen below in order to ensure an ability to drive over object 2.

After the execution of third method step 103, the method is executed in a loop in that the sequence branches back to first method step 101.

In general, for objects which are taller than sensor installation height h, the reflection points are (approximately) at sensor height due to the law of reflection and are thus located on sensor axis 3. Sensor installation height h is a distance in the embodiment shown in FIG. 2, in which acoustic sensor 1 is situated above a roadway surface at vehicle 5. For objects 2 smaller than sensor installation height h, the reflections are measured depending on object height at elevation angle θ corresponding to vertical sensor axis 3.

The transmission frequency of acoustic sensor 1 is changed over a preferably large frequency range to thus vary the aperture angle, and to analyze the curve of the standardized echo amplitude, i.e., the standardized signal amplitude of the received acoustic signal.

The standardized echo amplitude results during the standardization from the measured echo amplitude in consideration of the standardized directional pattern of the sensor with the aid of Aₙ=k(f)*A, i.e., by multiplication by a frequency-dependent correction factor k(f) where k(f)=1/A (f for θ=0°) (from which A=1 at θ=0° for all frequencies follows). Correction factor k(f) is thus a known design feature of the transducer. To achieve higher accuracies, k(f) may also be measured at the end of the line of a production line and stored in acoustic sensor 1.

Elevation angle θ may be deduced from the curve of the frequency-dependent standardized echo amplitude. Reflections on sensor main axis (θ=0°) display a constant echo amplitude curve (see FIG. 2). Shorter objects 2, in contrast, display an echo amplitude curve decreasing with increasing frequency depending on height, the curve itself being characteristic for the particular elevation angle, and thus for the object height. The curve is not dependent on the object distance; at greater object distances, θ is solely limited in the amount. The curves, and also the directional pattern, are a design feature and may be stored in the sensor for every elevation angle θ. The methods from the related art (for example, fitting, correlation analysis) may be used for the comparison of the measured data to the stored data.

A change of the transmission frequency not only effectuates a change in the vertical directional pattern, but rather also in the horizontal directional pattern, so that objects which not only have an azimuth offset and do not have an elevation offset (θ=0°) in relation to the main axis, also display a nonconstant echo curve. In asymmetrical ultrasonic transducers, on the one hand, the effect is not as strongly pronounced; on the other hand, it may be corrected for known azimuth angles. The azimuth angle results with the aid of trilateration in the sensor system.

To achieve a preferably accurate angle measurement, a preferably high number of transmission frequencies is desirable. This may take place by a corresponding sequence of short pulses having a fixed transmission frequency and equal duration, preferably in the range of 200 μs-400 μs. In general, however, the method may also be carried out using fewer pulses, but at least using two.

Alternatively, a frequency-modulated excitation may also be carried out using a rising or falling frequency, preferably using a linear change of the frequency over time. A design of the chirp having a long pulse duration, preferably in the range of 10 ms to 2 ms, is particularly advantageous.

The analysis of the echo amplitudes preferably takes place for this case by a filter bank having preferably finely divided rising mid-band frequencies of the filters. This method is thus more complex than the excitation using a fixed frequency, but has the advantage that the angle information is already available with one transmitting cycle.

The ratio of wavelength λ of the acoustic signal to the diaphragm diameter is decisive for the manifestation of an amplitude drop. It is therefore advisable not to permanently specify the transmission frequency bandwidth, but rather to restrict it via ratio λ/d. Varying ratio λ/d in the range of 1 to 0.5, but at least <0.8, appears to be particularly advantageous (proceeding from a low transmission frequency).

The method is also suitable during the driving operation of vehicle 5. However, there are also further features when driving which may be analyzed for a height classification. An application of particular interest for the method is the starting of the system for highly-automated vehicles. It thus appears particularly advantageous to provide a special “height measuring” operating mode after startup and then to reenter a normal measuring mode. It is possible to run through the “height measuring” mode either always after startup or only triggered by an object detection.

In addition to the above description, reference is explicitly made to the description of FIGS. 1 through 3.

1-10 (canceled)

11. A method for operating an acoustic sensor, comprising the following steps:
emitting an acoustic signal using, a first signal component of the acoustic signal having a first frequency and a second signal component of the acoustic signal having a second frequency, an aperture angle of the acoustic sensor differing for the first frequency and the second frequency;
receiving the acoustic signal using the acoustic sensor, after the acoustic signal has been reflected at an object; and
evaluating the received acoustic signal to ascertain an elevation angle based on a signal amplitude of the first signal component of the received acoustic signal and a signal amplitude of the second signal component of the received acoustic signal, the elevation angle describing a position deviation of the object from a sensor axis of the acoustic sensor.

12. The method as recited in claim 11, wherein the acoustic signal is a chirp.

13. The method as recited in claim 11, wherein the acoustic signal is a pulsed signal having pulses each of constant frequency.

14. The method as recited in claim 11, wherein, during the evaluation of the received acoustic signal, a standardization of the signal amplitudes of the first signal component and the second signal component takes place, and the elevation angle is ascertained based on a standardized signal amplitude of the first signal component of the received acoustic signal and a standardized signal amplitude of the second signal component of the received acoustic signal.

15. The method as recited in claim 11, wherein, during the evaluation of the received acoustic signal, a directional pattern of the acoustic sensor is accessed, which defines a relationship between signal amplitude of the received acoustic signal and elevation angle for the first frequency and for the second frequency.

16. The method as recited in claim 15, wherein the evaluation of the received acoustic signal includes a trilateration, a location of the object in relation to the acoustic sensor being described in an azimuth angle, in a horizontal direction in relation to the acoustic sensor, and a correction of the directional pattern taking place based on the azimuth angle.

17. The method as recited in claim 11, wherein a horizontal aperture angle of the acoustic sensor is greater than a vertical aperture angle of the acoustic sensor.

18. The method as recited in claim 11, wherein the acoustic sensor is an ultrasonic sensor, which has a diaphragm cup design.

19. The method as recited in claim 1, wherein the evaluation of the received acoustic signal is carried out in response to a system including the acoustic sensor having been started or a presence of an object having been detected.

20. A device for operating an acoustic sensor, comprising:
a control device configured to:
emit an acoustic signal using the acoustic sensor a first signal component of the acoustic signal having a first frequency and a second signal component of the acoustic signal having a second frequency, an aperture angle of the acoustic sensor differing for the first frequency and the second frequency;
receive the acoustic signal, using the acoustic sensor, after the acoustic signal has been reflected at an object; and
evaluate the received acoustic signal to ascertain an elevation angle based on a signal amplitude of the first signal component of the received acoustic signal and a signal amplitude of the second signal component of the received acoustic signal, the elevation angle describing a position deviation of the object from a sensor axis.
